(19) United States
(12) Patent Application Publication
(10) Pub. No.: US 2026/0344713 A1
(43) Pub. Date: Nov. 5, 2026

(54) MICROWAVABLE FOODS WITH DOUGH LAYER

(71) Applicant: SFC GLOBAL SUPPLY CHAIN, INC., Marshall, MN (US)

(72) Inventors: Brenda Bauer, Marshall, MN (US); Gaëlle Denais-Kruse, Marshall, MN (US); Bonita Hinze, Marshall, MN (US); Wayne Pafko, Marshall, MN (US); Ryan Holmberg, Marshall, MN (US)

(21) Appl. No.: 19/663,627

(22) Filed: Apr. 30, 2026

Related U.S. Application Data
(60) Provisional application No. 63/798,324, filed on May 1, 2025.

(51) Int. Cl. A23L 5/10; A21D 13/41

(52) U.S. Cl. CPC A23L 5/15; A21D 13/41

(57) ABSTRACT

Microwavable foods comprising a dough layer having a plurality of grooves in the bottom surface of the dough layer and extending up a perimeter sidewall of the dough layer. The plurality of grooves direct the travel of steam from the bottom surface of the dough layer, up the perimeter sidewall, and away from the microwavable food during microwaving to produce an evenly heated and crisp microwavable food.

### CROSS REFERENCE TO RELATED APPLICATIONS

This application claims the benefit of and priority to U.S. Provisional Application No. 63/798,324 filed May 1, 2025, the disclosure of which is hereby incorporated by reference in its entirety.

### BACKGROUND

Microwaving food allows for quick and easy meal preparation with minimal effort. Unlike traditional cooking methods, microwaves heat food rapidly, reducing overall cooking times. However, microwaving foods comprising dough often leads to issues with texture and consistency. Instead of crisping the dough layer, microwaves often produce soggy or tough dough. This can result in a dough layer that lacks the desired crunch or flakiness, especially in items like pies, pastries, and pizza.

It is against this background that the present disclosure is made.

### SUMMARY

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

Disclosed herein is a method of making a microwavable food, the method comprising: removing the microwavable food from a package, wherein the microwavable food comprises a dough layer comprising: a top surface; a bottom surface; a perimeter sidewall extending between the top surface and the bottom surface; and a plurality of grooves extending radially from a central location on the bottom surface to an outer circumference of the dough layer and further extending at least partially up the perimeter sidewall, wherein each of the plurality of grooves terminates on the perimeter sidewall; placing the microwavable food in a heating appliance; and cooking the microwavable food in accordance with instructions provided with the microwavable food.

Also disclosed herein is a microwavable food, comprising: a dough layer comprising: a top surface; a bottom surface; a perimeter sidewall extending between the top surface and the bottom surface; and a plurality of grooves extending radially from a central location on the bottom surface to an outer circumference of the dough layer and further extending at least partially up the perimeter sidewall, wherein each of the plurality of grooves terminates on the perimeter sidewall.

Also disclosed herein is a packaged microwavable food product comprising: a microwavable food comprising: a dough layer comprising: a top surface, a bottom surface; a perimeter sidewall extending between the top surface and the bottom surface; and a plurality of grooves extending radially from a central location on the bottom surface to an outer circumference of the dough layer and further extending at least partially up the perimeter sidewall, wherein each of the plurality of grooves terminates on the perimeter sidewall; and an outer packaging that encloses the microwavable food.

Also disclosed here in is a slice of a microwavable pizza comprising: a dough layer comprising: a top surface; a bottom surface; and a perimeter sidewall, wherein the perimeter sidewall extends between the top surface and the bottom surface; at least one groove extending along the bottom surface and further extending at least partially up the perimeter sidewall, wherein the at least one groove terminates on the perimeter sidewall.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a microwavable food in accordance with the present disclosure.

FIG. 2 is a close up view of a groove in a dough layer in accordance with the present disclosure.

FIG. 3 is a perspective view of a slice of pizza in accordance with the present disclosure.

FIG. 4A is a perspective view of a pan in accordance with the present disclosure.

FIG. 4B is a perspective view of a multi-cavity pan in accordance with the present disclosure.

FIG. 5 is a close up view of a tapered angle of a pan ridge in accordance with the present disclosure.

FIG. 6 is a schematic illustration of a microwavable food in a package in accordance with the present disclosure.

FIG. 7 is a schematic representation of microwaving a microwavable food in accordance with the present disclosure.

FIGS. 8A-8D are alternative depictions of a dough layer in accordance with the present disclosure.

FIG. 9 is a bottom view of a groove in a dough layer in accordance with the present disclosure.

FIGS. 10A-10D are images from an IR thermal reading of a pizza taken during microwaving in accordance with the present disclosure.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

As used herein, the term “substantially” with reference to shapes, dimensions, angles, and measurements indicates that the shapes, dimensions, angles, and measurements may vary due to machinery or material limitations, or variations in the appearance of dough due to the malleability of dough caused by chemical reactions within the dough. For example, references to “substantially circular” may refer to a shape that is intended to be circular but may deviate from a perfect circle shape due to limitations in machining feasibility and/or the inability to produce a perfect circle of dough as dough is not a static material. As another example, references to “substantially perpendicular” may refer to an angle that is intended to form a 90 degree angle but may deviate +/- 5% from the intended angle due to machining tolerances and/or to account for expansion and rising of dough.

As used herein, the term “about” modifying a measurement refers to variation in the numerical quantity that can occur, for example, through typical measuring procedures, machinery or material limitations, or variations in the appearance of dough due to the malleability of dough caused by chemical reactions within the dough; through inadvertent error in these procedures; and the like. For example, reference to a dimension with “about” modifying the dimensional value may deviate +/- 5% due to machining tolerances and/or to account for expansion and rising of dough. Whether or not modified by the term “about,” the claims include equivalents to the quantities.

As used herein, the term “radial” or “radially” with reference to the direction or orientation of grooves refers to a direction that extends outward from a central point toward an outer edge or circumference. For example, references to grooves extending “radially” from a central location may refer to grooves that extend in a direction generally away from the center of the dough layer toward the outer circumference, in a manner similar to the spokes of a wheel extending outward from a hub. The term does not require that the grooves extend in a perfectly straight line from the exact geometric center of the dough layer, as minor deviations in direction or origin may occur due to machinery or material limitations, or variations in the appearance of dough due to the malleability of dough caused by chemical reactions within the dough.

Using microwaves to cook or reheat food provides consumers with a fast and convenient way to prepare food with minimal time or effort. However, microwaving food presents challenges, particularly for foods with a dough layer. Microwaves are electromagnetic waves that cause dipolar rotation and ionic conduction of molecules in the food, which generate heat. These electromagnetic waves are unevenly distributed throughout the microwave cavity. Differences in the food composition result in different heating. Uneven distribution of the electromagnetic waves along with the varying composition of the food can cause some areas of the food to be overheated and others underheated.

Some issues with microwave cooking are addressed by using susceptors, which can help create a crisp or browned texture, particularly at the points where the food contacts the susceptor. However, susceptors alone often do not fully address uneven heating and moisture content and movement within a microwaved food item.

The present application addresses concerns with uneven heating and moisture imbalances in microwave cooking by using a plurality of grooves on the bottom surface of the food. The plurality of grooves typically are located on the bottom surface and side surfaces of the food to allow for steam to escape from the bottom surface, through the plurality of grooves, during microwaving. The escape of steam through the plurality of grooves prevents or minimizes the retention of steam underneath the food in the microwave, which otherwise may contribute to sogginess or toughness of the food item.

The plurality of grooves on the bottom side and side surfaces of the food can be created using a pan with a plurality of ridges that imprint correspondingly sized grooves on a surface of the food item.

The present application also describes methods of making a microwavable food with a dough layer that comprises a plurality of grooves. The methods produce a final microwaved food product that minimizes uneven heating and moisture imbalances.

The microwavable food described herein may be any microwavable food that comprises a dough layer, including but not limited to, pizza, flatbread, calzone, stromboli, empanada, sope, samosa, meat pie, sausage roll, pot pie, pasty, pretzels, bread, breadstick, cookie, cake, donut, pastry, churro, scone, tart, quiche, bao bun, dumpling, and other dough-comprising foods.

For the sake of illustration, the present application uses a pizza as an example microwavable food in some of the Figures. The descriptions throughout the present application are intended to cover all foods with a dough layer, not just pizza.

Described herein are microwavable foods and methods of making microwavable foods. However, the present disclosure also contemplates food products with the described features that are not for microwaving and instead may be more suitable for baking, air frying, steaming, or other cooking methods. Descriptions herein of “microwavable foods” are also applicable to formation of baked foods, fried foods, steamed foods, and the like.

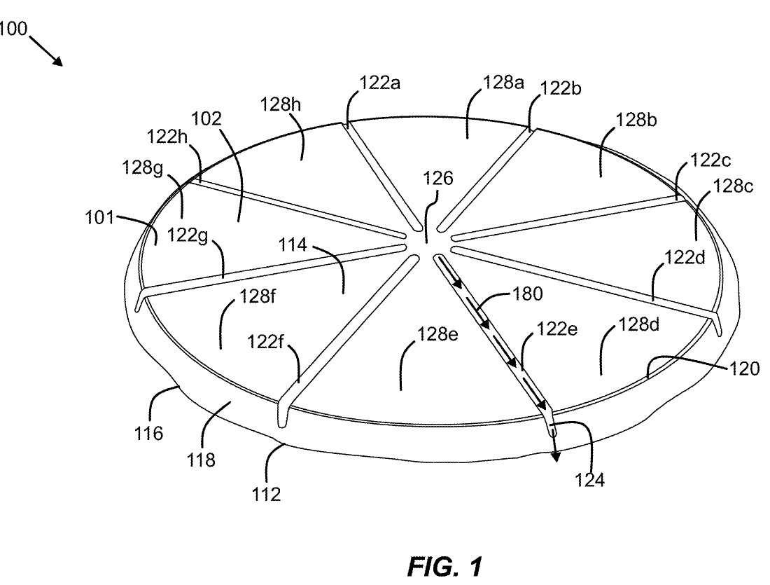

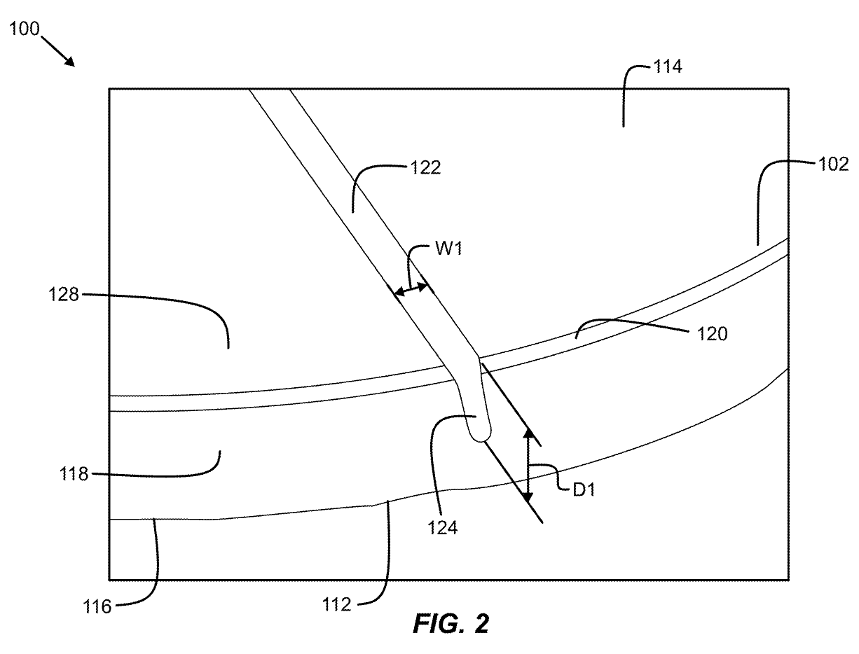

FIGS. 1 and 2 illustrate a microwavable food 100. The microwavable food 100 in FIGS. 1 and 2 is a pizza 101. Pizza 101 comprises a dough layer 102. The dough layer 102 comprises a top surface 112 opposite a bottom surface 114. For the purpose of visualization, FIGS. 1 and 2 show the underside of the pizza 101 such that the features on the bottom surface 114 are visible. A perimeter sidewall 118 extends between the top surface 112 and the bottom surface 114 around a perimeter of the dough layer 102. The top surface 112 and the perimeter sidewall 118 meet at top edge 116. The bottom surface 114 and the perimeter sidewall 118 meet at outer circumference 120.

In some examples, the perimeter sidewall 118 is a circumferential sidewall. In such examples, the shape of the dough layer 102 is circular, substantially circular, oval shaped, or otherwise rounded.

In some examples, the perimeter sidewall 118 is a polygonal sidewall having a polygonal shape. For example, the perimeter sidewall 118 may be shaped as a square, a rectangle, a triangle, a trapezoid, or other polygon.

In some examples, the perimeter sidewall 118 is oriented substantially perpendicularly to the bottom surface 114 such that the perimeter sidewall 118 and the bottom surface 114 meet at substantially a 90 degree angle. Due to manufacturing limitations and the malleable nature of dough, “substantially perpendicularly” may not be precisely 90 degrees.

In some examples, the perimeter sidewall 118 is oriented an oblique, non-90 degree angle relative to the bottom surface 114.

The bottom surface 114 of the dough layer 102 comprises a plurality of grooves 122. The bottom surface 114 may comprise any integer number of grooves (122a, 122b, 122c, etc.). The bottom surface 114 may comprise 2 to 12 grooves. The bottom surface 114 may comprise 1 groove, 2 grooves, 3 grooves, 4 grooves, 5 grooves, 6 grooves, 7 grooves, 8 grooves, 9 grooves, 10 grooves, 11 grooves, 12 grooves, 13 grooves, 14 grooves, 15 grooves, 16 grooves, 17 grooves, 18 grooves, 19 grooves, 20 grooves, 21 grooves, 22 grooves, 23 grooves, 24 grooves, 25 grooves, 26 grooves, 27 grooves, 28 grooves, 29 grooves, or 30 grooves. The bottom surface 114 may comprise 2 to 10 grooves, 2 to 8 grooves, 2 to 6 grooves, 2 to 4 grooves, 4 to 12 grooves, 6 to 12 grooves, 8 to 12 grooves, or 10 to 12 grooves. The bottom surface 114 may comprise 2 to 30 grooves, 4 to 25 grooves, 6 to 20 grooves, or 10 to 15 grooves.

In some examples, the plurality of grooves 122 are arranged on the bottom surface 114 of dough layer 102 in a radial pattern. The plurality of grooves may extend radially from a central location 126 of the dough layer 102 to an outer circumference 120 of the dough layer 102. The grooves may further extend from the outer circumference 120 at least partially up the perimeter sidewall 118 and terminate on the perimeter sidewall 118.

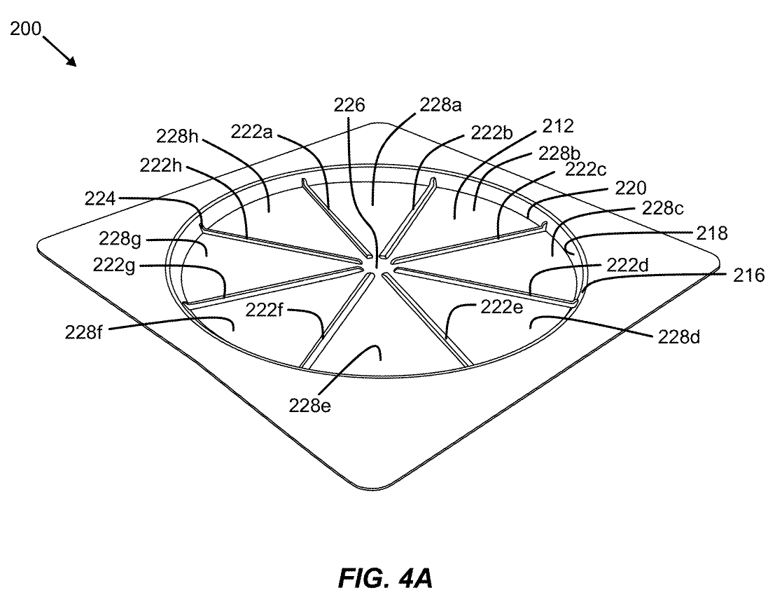

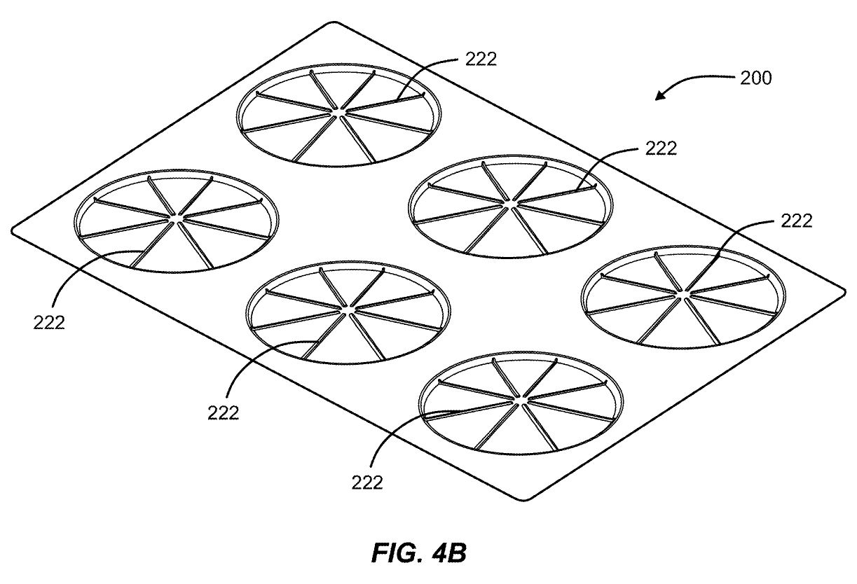

A radial pattern of the plurality of grooves (or the plurality of ridges, discussed below with reference to FIG. 4) refers to an orientation in which first ends of each of the grooves are oriented about a common central location and extend outwardly, diverging from the common central location to outer points where second ends of each of the grooves terminates.

In some examples, the dough layer 102 may comprise multiple central locations 126 with multiple radial patterns of pluralities of grooves 122. For example, a dough layer 102 may be a large piece of dough in which it would be beneficial to have multiple central locations 126 with multiple sets of the plurality of grooves 122 on the dough layer 102 to allow for increased direction of steam from the underside of the large piece of dough. The direction of the steam may be referred to as orderly movement, which follows a predictable path (e.g., away from the underside of the dough layer 102).

In other examples, the dough layer 102 might have a shape that would benefit from having multiple central locations 126 with multiple sets of the plurality of grooves 122, such as a baguette shape, where a length of the dough layer is substantially greater than a width of the dough layer.

The central location 126 is located substantially in the center of the bottom surface 114 of dough layer 102. The central location 126 is free from grooves and is substantially flat, though variations in the surface of the dough layer 102 may be present due to the malleable nature of dough.

The substantially flat surface of the central location 126 is free from grooves or other intentional variations in the surface of the dough layer 102. The substantially flat surface of the central location 126 may be flush with the remainder of the dough layer 102, including flat portions 128. However, in some examples, the substantially flat surface of the central location 126 may be raised relative to rest of the dough layer 102, including the flat portions 128.

The central location 126 may be any suitable shape or configuration including, but not limited to, substantially circular, substantially square, substantially rectangular, or any other polygonal shape.

In some examples, each of the plurality of grooves 122 has a depth D1. In some examples, the depth D1 of each groove 122 in the bottom surface 114 of the dough layer 102 is measured from the bottom surface 114 of the dough layer to the lowest depth of the groove recessed in the bottom surface 114, as indicated by dimension D1 in FIG. 2.

The depth of the groove may be about 1 mm to about 8 mm, about 1 mm to about 7 mm, about 1 mm to about 6 mm, about 1 mm to about 5 mm, about 1 mm to about 4 mm, about 1 mm to about 3 mm, about 1 mm to about 2 mm, about 2 mm to about 8 mm, about 3 mm to about 8 mm, about 4 mm to about 8 mm, about 5 mm to about 8 mm, about 6 mm to about 8 mm, or about 7 mm to about 8 mm.

In some examples, the depth of the plurality of grooves 122 is substantially the same for each of the plurality of grooves 122. However, the depth for each of the plurality of grooves 122 may not be identical due to manufacturing limitations and the behavior of dough that may rise and/or bake unevenly.

In some examples, the depth of the plurality of grooves 122 is not the same for each of the plurality of grooves 122. In some examples, the depth of a groove in the plurality of grooves 122 may vary along the length of the groove. Variations in the depth of the plurality of grooves 122 or variation in the depth of a single groove 122 may be incorporated to assist in steam migration from the underside of the dough layer 102. For example, a dough layer 102 with a non-circular shape may include a plurality of groves 122 of varying length due to the non-circular nature of the dough layer 102. In such examples, a groove 122 that is shorter in length than other grooves 122 may have a depth that is greater than, less than, or varies relative to other grooves 122 to assist in steam direction from the underside of the dough layer 102.

In some examples, each of the plurality of the grooves 122 has a width W1. In some examples, the width W1 of the groove in the bottom surface 114 of the dough layer 102 is measured from opposite sides of the groove that are oriented substantially perpendicularly to the bottom surface 114, as indicated by the dimension W1 in FIG. 2.

The width of the groove may be about 1 mm to about 6 mm, about 1 mm to about 5 mm, about 1 mm to about 4 mm, about 1 mm to about 3 mm, about 1 mm to about 2 mm, about 2 mm to about 6 mm, about 3 mm to about 6 mm, about 4 mm to about 6 mm, or about 5 mm to about 6 mm.

In some examples, the width of the plurality of grooves 122 is substantially the same for each of the plurality of grooves 122. However, the width for each of the plurality of grooves 122 may not be identical due to manufacturing limitations and the behavior of dough that may rise and/or bake unevenly.

In some examples, the width of the plurality of grooves 122 is not the same for each of the plurality of grooves 122. In some examples, the width of a groove in the plurality of grooves 122 may vary along the length of the groove. Variations in the width of the plurality of grooves 122 or variation in the width of a single groove 122 may be incorporated to assist in steam migration from the underside of the dough layer 102. For example, a dough layer 102 with a non-circular shape may include a plurality of groves 122 of varying length due to the non-circular nature of the dough layer 102. In such examples, a groove 122 that is shorter in length than other grooves 122 may have a width that is greater than, less than, or varies relative to other grooves 122 to assist in steam direction from the underside of the dough layer 102.

The plurality of grooves 122 may terminate at any location on the perimeter sidewall 118. In some examples, each of the plurality of grooves 122 may terminate on the perimeter sidewall 118 about halfway between the top edge 116 and the outer circumference 120. In some examples, each of the plurality of grooves 122 may terminate on the perimeter sidewall 118 at a location below the top edge 116.

In some examples, each of the plurality of grooves 122 may terminate at the top edge 116 of the dough layer where the top surface 112 meets the perimeter sidewall 118. When each of the plurality of grooves 122 terminates at the top edge 116, the plurality of grooves may be visible from the top surface 112 of the dough layer 102 from a birds-eye view.

In some examples, the plurality of grooves 122 terminate on the perimeter sidewall 118 at a tapered angle 124. The tapered angle 124 may be about 5 degrees to about 90 degrees The tapered angle provides a gradual decrease of a depth of each of the plurality of grooves 122 relative to the surface of the perimeter sidewall 118, which aids in steam passage from the bottom surface 114 of the dough layer 102 (which is discussed further below).

In examples where the tapered angle 124 is 90 degrees, the angle is not a true taper extending from the groove 122 to the perimeter sidewall 118. Instead, the tapered angle 124 having a 90 degree angle means that the angle of the groove is substantially perpendicular relative to the perimeter sidewall 118.

The tapered angle 124 may be about 5 degrees to about 90 degrees, about 10 degrees to about 90 degrees, about 15 degrees to about 90 degrees, about 20 degrees to about 90 degrees, about 25 degrees to about 90 degrees, about 30 degrees to about 90 degrees, about 35 degrees to about 90 degrees, about 40 degrees to about 90 degrees, about 45 degrees to about 90 degrees, about 50 degrees to about 90 degrees, about 55 degrees to about 90 degrees, about 60 degrees to about 90 degrees, about 65 degrees to about 90 degrees, about 70 degrees to about 90 degrees, about 75 degrees to about 90 degrees, about 80 degrees to about 90 degrees, about 85 degrees to about 90 degrees, about 5 degrees to about 85 degrees, about 5 degrees to about 80 degrees, about 5 degrees to about 75 degrees, about 5 degrees to about 70 degrees, about 5 degrees to about 65 degrees, about 5 degrees to about 60 degrees, about 5 degrees to about 55 degrees, about 5 degrees to about 50 degrees, about 5 degrees to about 45 degrees, about 5 degrees to about 40 degrees, about 5 degrees to about 35 degrees, about 5 degrees to about 30 degrees, about 5 degrees to about 25 degrees, about 5 degrees to about 20 degrees, about 5 degrees to about 15 degrees, or about 5 degrees to about 10 degrees.

In examples where the plurality of grooves 122 terminate on the perimeter sidewall 118 at a tapered angle 124, the depth D1 of each groove 122 on the perimeter sidewall 118 is the same depth D1 as each groove on the bottom surface 114 before reaching the tapered angle 124. The depth D1 will begin to gradually decrease at tapered angle 124 such that the depth of the groove 122 reaches substantially zero depth relative to the plane of the perimeter sidewall 118.

In some examples, the tapered angle 124 for each of the plurality of grooves 122 is substantially the same. However, the tapered angle 124 for each of the plurality of groves 122 may not be identical due to manufacturing limitations and the behavior of dough that may rise and/or bake unevenly.

In between the plurality of grooves 122 on the bottom surface 114 of the dough layer 102 are flat portions 128. The flat portions 128 are free from any grooves but may comprise variations in the surface due to behavior of the dough layer. However, in some examples, the flat portions 128 may include deviations in the surface, such as protrusions, recesses, or any other suitable pattern or texture. In FIGS. 1-2, the flat portions 128 are substantially triangular in shape due to the circular perimeter sidewall 118 and radial nature of the plurality of grooves 122, however, the flat portions 128 may be any polygonal shape.

The dough layer 102 may be any shape including, but not limited to, circular, oval, square, rectangle, triangular, trapezoidal, or other polygon. In the examples shown in FIGS. 1 and 2, the dough layer 102 is a substantially circular shape.

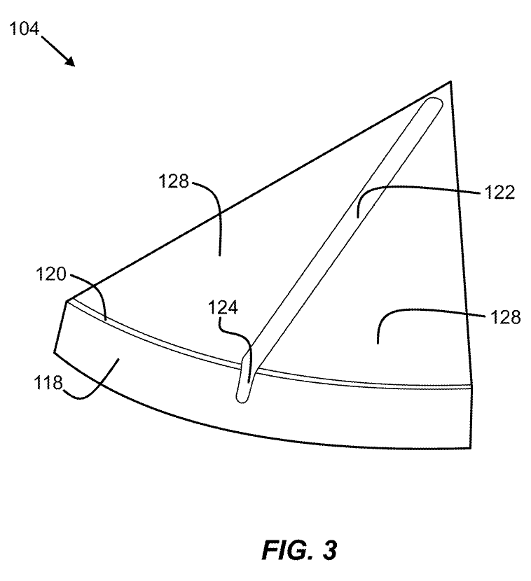

In the example shown in FIG. 3, the dough layer 102 is in a substantially triangular shape, which may represent a slice 104 of pizza 101. In some examples, a slice 104 of pizza may represent a small portion of the whole pizza 101 in FIGS. 1 and 2. The slice 104 in FIG. 3 may comprise a top surface 112 and a bottom surface 114 (shown in FIGS. 1-2) with perimeter sidewall 118 extending between the top surface 112 and the bottom surface 114. The slice 104 may also comprise at least one groove 122 extending across the bottom surface 114. The at least one groove 122 may be located at any portion of the bottom surface 114 of the slice 104.

The dough layer 102 described herein may be formed using a pan 200, as shown in FIG. 4. Pan 200 may be shaped in a manner to produce the dough layer 102 of pizza 101. In examples, the dough layer 102 is formed by taking a raw piece of dough and pressing the dough into the pan 200 to form the dough layer 102 into the shape of the pan 200. The dough may be pressed to form dough layer 102 by any suitable means, including using a dough press or other machinery, or by hand. When the dough piece is pressed into pan 200, the dough piece forms dough layer 102 that has conformed to the shape of pan 200. Therefore, the shape, size, dimensions, and features of dough layer 102 are dependent upon the corresponding components of the pan 200.

FIG. 4 shows pan 200 having a top surface 212 opposite a bottom surface 214. A pan sidewall 218 extends between the top surface 212 and a rim 216. The rim 216 of the pan 200 may be formed as a curved lip or may be formed as part of a sheet of material, as shown in the example in FIG. 4.

In some examples, the pan sidewall 218 is a circumferential sidewall. In such examples, the shape of the pan 200 is circular, substantially circular, oval shaped, or otherwise rounded.

In some examples, the pan sidewall 218 is a polygonal sidewall having a polygonal shape. For example, the pan sidewall 218 may be shaped as a square, a rectangle, a triangle, a trapezoid, or other polygon.

In some examples, the pan sidewall 218 is oriented substantially perpendicularly to the bottom surface 214 such that the pan sidewall 218 and the bottom surface 214 meet at substantially a 90 degree angle. Due to manufacturing limitations of the material used to form pan 200, “substantially perpendicularly” may not be precisely 90 degrees.

In some examples, the pan sidewall 218 is oriented at an oblique, non-90 degree angle relative to the bottom surface 214.

Pan 200 comprises a plurality of ridges 222 on the top surface 212 of the pan 200. The top surface 212 may comprise any integer number of ridges (222a, 222b, 222c, etc.). The top surface 212 may comprise 2 to 12 ridges. The top surface 212 may comprise 1 ridge, 2 ridges, 3 ridges, 4 ridges, 5 ridges, 6 ridges, 7 ridges, 8 ridges, 9 ridges, 10 ridges, 11 ridges, 12 ridges, 13 ridges, 14 ridges, 15 ridges, 16 ridges, 17 ridges, 18 ridges, 19 ridges, 20 ridges, 21 ridges, 22 ridges, 23 ridges, 24 ridges, 25 ridges, 26 ridges, 27 ridges, 28 ridges, 29 ridges, 30 ridges. The top surface 212 may comprise 2-10 ridges, 2-8 ridges, 2-6 ridges, 2-4 ridges, 4-12 ridges, 6-12 ridges, 8-12 ridges, or 10-12 ridges. The top surface 212 may comprise 2-30 ridges, 4-25 ridges, 6-20 ridges, or 10-15 ridges.

In some examples, the plurality of ridges 222 are arranged on the top surface 212 of pan 200 in a radial pattern. The plurality of ridges 222 may extend radially from a central location 226 of pan 200 to an outer circumference 220 of pan 200. The ridges may further extend from the outer circumference 220 at least partially up the pan sidewall 218 and terminate on the pan sidewall 218.

A radial pattern of the plurality of ridges refers to an orientation in which first ends of each of the ridges are oriented about a common central location and extend outwardly, diverging from the common central location to outer points where second ends of each of the ridges terminates.

In some examples, the pan 200 may comprise multiple central locations 226 with multiple radial patterns of pluralities of ridges 222. For example, the pan 200 may be a large pan in which it would be beneficial to have multiple central locations 226 with multiple sets of the plurality of ridges 222 on the top surface 212 to allow for increased direction of steam across a larger surface.

In other examples, the pan 200 may be formed from one sheet of material (such as metal) that comprises a plurality of cavities comprising the sets of the plurality of ridges 222 and other features described herein with respect to pan 200. The pan 200 may be machined such that multiple dough layers 102 can be formed from a single pan. An example representation is shown in FIG. 4B. The pan 200 may be used to form dough layer 102 continuously or in a batch process.

For example, a pan 200 may be machined to have six cavities with each cavity having a set of the plurality of ridges 222, as shown in FIG. 4B, and other features of the pan 200 described herein. In such examples, six dough layers 102 may be formed using a pan 200 having six cavities. The pan 200 may have any integer number of cavities with the corresponding set of the plurality of ridges 222 and other features of the pan 200 described herein. The pan 200 may comprise 2-12 cavities, 2-10 cavities, 2-8 cavities, 2-6 cavities, 2-4 cavities, 4-12 cavities, 6-12 cavities, 8-12 cavities, or 10-12 cavities.

The central location 226 of pan 200 is located substantially in the center of the top surface 212 of pan 200. The central location 226 is free from ridges and is substantially flat, though variations in the surface may be present due to manufacturing limitations and properties of the material used to construct pan 200.

The substantially flat surface of the central location 226 is free from ridges or other intentional variations in the surface of the pan 200. However, in some examples, flat portions 128 may include deviations in the surface, such as protrusions, recesses, or any other suitable pattern or texture. The substantially flat surface of the central location 226 may be flush with the remainder of the pan 200, including the flat portions 228. However, in some examples, the substantially flat surface of the central location 226 may be raised relative to rest of the flat portions 228.

The central location 226 may any suitable shape or configuration including, but not limited to, substantially circular, substantially square, substantially rectangular, or any other polygonal shape.

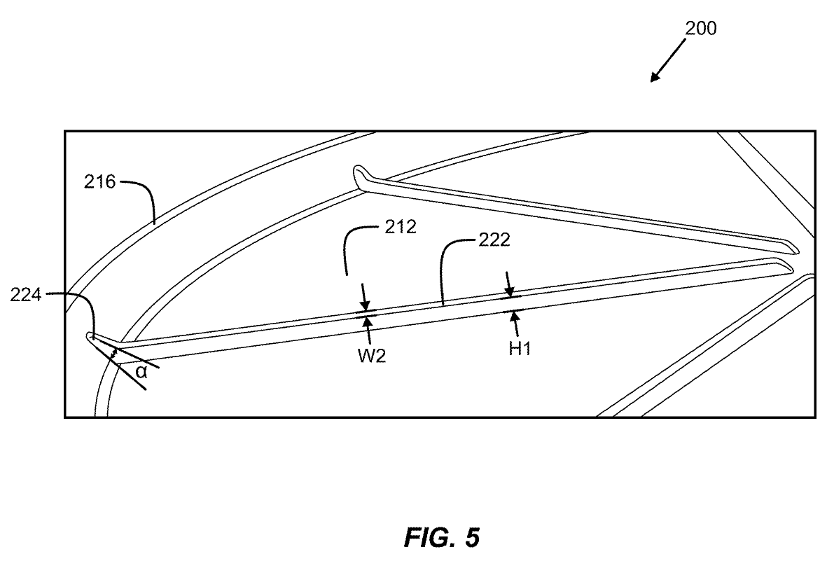

Each of the plurality of ridges 222 has a height. The height of each of the plurality of ridges 222 is measured from the top surface 212 of the pan 200 to the tallest part of the ridge 222, as indicated in FIG. 5 by the dimension H1.

In some examples, the height H1 of each of the plurality of ridges 222 is about 1 mm to about 8 mm, about 1 mm to about 7 mm, about 1 mm to about 6 mm, about 1 mm to about 5 mm, about 1 mm to about 4 mm, about 1 mm to about 3 mm, about 1 mm to about 2 mm, about 2 mm to about 8 mm, about 3 mm to about 8 mm, about 4 mm to about 8 mm, about 5 mm to about 8 mm, about 6 mm to about 8 mm, or about 7 mm to about 8 mm.

In some examples, the height H1 of each of the plurality of ridges 222 is substantially the same for each of the plurality of ridges 222. However, the height for each of the plurality of ridges 222 may not be identical due to manufacturing limitations and machining tolerances for forming the ridges 222.

In some examples, the height of the plurality of ridges 222 is not the same for each of the plurality of ridges 222. In some examples, the height of a ridge in the plurality of ridges 222 may vary along the length of the ridge. Variations in the height of the plurality of ridges 222 or variation in the depth of a single ridge 222 may be incorporated to assist in steam migration from the underside of the dough layer 102. For example, a pan 200 with a non-circular shape may include a plurality of ridges 222 of varying length due to the non-circular nature of the pan 200. In such examples, a ridge 222 that is shorter in length than other ridges 222 may have a height that is greater than, less than, or varies relative to other ridges 222 to assist in steam direction from the underside of the dough layer 102.

Each of the plurality of ridges has a width W2. In some examples, the width W2 of each of the ridges 122 is measured from opposite sides of each ridge oriented substantially perpendicularly to the top surface 212 of the pan 200, as shown by the dimension H1 in FIG. 5.

The width W2 may be about 1 mm to about 6 mm, about 1 mm to about 5 mm, about 1 mm to about 4 mm, about 1 mm to about 3 mm, about 1 mm to about 2 mm, about 2 mm to about 6 mm, about 3 mm to about 6 mm, about 4 mm to about 6 mm, or about 5 mm to about 6 mm.

In some examples, the width W2 of each of the plurality of ridges 222 is substantially the same for each of the plurality of ridges 222. However, the width for each of the plurality of ridges 222 may not be identical due to manufacturing limitations and machining tolerances for forming the ridges 222.

In some examples, the width of the plurality of ridges 222 is not the same for each of the plurality of ridges 222. In some examples, the width of a ridge in the plurality of ridges 222 may vary along the length of the ridge. Variations in the width of the plurality of ridges 222 or variation in the width of a single ridge 222 may be incorporated to assist in steam migration from the underside of the dough layer 102. For example, a pan 200 with a non-circular shape may include a plurality of ridges 222 of varying length due to the non-circular nature of the pan 200. In such examples, a ridge 222 that is shorter in length than other ridges 222 may have a width that is greater than, less than, or varies relative to other ridges 222 to assist in steam direction from the underside of the dough layer 102.

The plurality of ridges 222 may terminate at any location on the pan sidewall 218. In some examples, each of the plurality of ridges 222 may terminate on the pan sidewall 218 about halfway between the rim 216 and the outer circumference 220 of the pan 220.

In some examples, each of the plurality of ridges 222 may terminate on the pan sidewall 218 at the rim 216.

In some examples, the plurality of ridges 222 terminate on the pan sidewall 218 at a tapered angle 224. FIG. 5 shows that the tapered angle 224 may be measured as indicated by angle α. The tapered angle 224 may be about 5 degrees to about 90 degrees. The tapered angle 224 provides a gradual decrease of a height of each of the plurality of ridges 222 to the surface of the pan sidewall 218, which creates correspondingly sized grooves in a dough layer 102 to aid in steam passage.

In examples where the tapered angle 224 is 90 degrees, the angle is not a true taper extending from the ridge 222 to the pan sidewall 218. Instead, the tapered angle 224 having a 90 degree angle means that the angle of the ridge is substantially perpendicular relative to the pan sidewall 218.

The tapered angle 224 may be about 5 degrees to about 90 degrees, about 10 degrees to about 90 degrees, about 15 degrees to about 90 degrees, about 20 degrees to about 90 degrees, about 25 degrees to about 90 degrees, about 30 degrees to about 90 degrees, about 35 degrees to about 90 degrees, about 40 degrees to about 90 degrees, about 45 degrees to about 90 degrees, about 50 degrees to about 90 degrees, about 55 degrees to about 90 degrees, about 60 degrees to about 90 degrees, about 65 degrees to about 90 degrees, about 70 degrees to about 90 degrees, about 75 degrees to about 90 degrees, about 80 degrees to about 90 degrees, about 85 degrees to about 90 degrees, about 5 degrees to about 85 degrees, about 5 degrees to about 80 degrees, about 5 degrees to about 75 degrees, about 5 degrees to about 70 degrees, about 5 degrees to about 65 degrees, about 5 degrees to about 60 degrees, about 5 degrees to about 55 degrees, about 5 degrees to about 50 degrees, about 5 degrees to about 45 degrees, about 5 degrees to about 40 degrees, about 5 degrees to about 35 degrees, about 5 degrees to about 30 degrees, about 5 degrees to about 25 degrees, about 5 degrees to about 20 degrees, about 5 degrees to about 15 degrees, or about 5 degrees to about 10 degrees.

In examples where the plurality of ridges 222 terminate on the pan sidewall 218 at a tapered angle 224, the height H1 of each ridge 222 on the pan sidewall 218 is the same height H1 as each ridge on the top surface 212 before reaching the tapered angle 224. The height H1 will begin to gradually decrease at tapered angle 224 such that the height of the ridge 222 reaches substantially zero height relative to the plane of the pan sidewall 218.

In some examples, the tapered angle 224 for each of the plurality of ridges 222 is substantially the same. However, the tapered angle 224 for each of the plurality of ridges 222 may not be identical due to machining limitations and acceptable tolerances in machining the material of the pan 200.

In between the plurality of ridges 222 on the top surface 212 of the pan 200 are flat portions 228. The flat portions 228 are free from any ridges and are substantially smooth and flat but may comprise slight variations due to machining tolerances and the material used to form the pan 200. In FIG. 4, the flat portions 228 are substantially triangular in shape due to the circular pan sidewall 218 and radial nature of the plurality of ridges 222, however, the flat portions 228 may be any polygonal shape.

The pan 200 and dough layer 102 described herein are correspondingly sized to each other such that the dough layer 102 forms an inverse shape of the pan 200 when the dough layer 102 is formed by pressing a dough piece into pan 200. Therefore, the height H1 of a ridge 222 of pan 200 will form a groove 122 with a depth D1 that is substantially the same as height H1. However, depth D1 and height H1 may vary slightly due to the nature of dough, which is malleable due to reactions occurring within the dough. H1 and D1 are expected to be substantially the same prior to fermentation and baking as the plurality of grooves 122 are formed in the dough layer 102 prior to baking. Similarly the width W2 of ridge 222 on pan 200 will form a groove 122 with a width W1 that is substantially the same as width W2. However, width W1 and width W2 may vary slightly due to the nature of dough, which is malleable due to reactions occurring within the dough. W1 and W2 are expected to be substantially the same prior to fermentation and baking as the plurality of grooves 122 are formed in the dough layer 102 prior to baking. After fermentation or baking, H1 and D1, and W1 and W2, are likely to vary more from each other as dough likely will rise and expand during baking, while the dimensions H1 and W2 of the pan are static and do not change.

As described above, the dough layer 102 may be formed by pressing a dough piece into pan 200. The plurality of grooves 122 formed in the dough layer 102 allow for steam to be routed from the bottom surface 114 of the dough layer 102, through the plurality of grooves 122 on the bottom surface 114 and the perimeter sidewall 118, and away from the dough layer 102.

In some examples, the dough layer 102 is formed by stamping the plurality of grooves 122 into a dough piece to form a dough layer 102. In some examples, the dough layer 102 may be formed by extruding dough through an extruder comprising corresponding features to pan 200. In some examples, the dough layer 102 may be formed by sheeting dough and imprinting the dough layer 102 with pan 200. In some examples, a hot-press system may be used in which a die imprints the plurality of grooves 122 into the dough layer 102. Other methods of producing a dough layer 102 with a plurality of grooves 122 are contemplated herein. In some examples, the dough layer 102 is formed using any of the methods described herein in a batch (e.g., multiple dough layers 102 stamped/extruded/sheeted/imprinted at once) or in a continuous manner (e.g., a dough layer 102 formed as part of an assembly line process of continuous production).

The steam routing functionality can occur in multiple ways. The dough layer 102 is formed while the dough is in a raw state. The dough layer 102 may then be baked or cooked within pan 200 in accordance with any suitable method of baking or cooking including, but not limited to, oven baking, convection baking, induction baking, air frying, microwave cooking, steaming, and combinations thereof.

The baking or cooking methods described herein may be accomplished with any suitable heating appliance. Heating appliances may include but are not limited to ovens, air fryers, microwaves, and steamers.

As used herein, “baked” or “baking” may refer to a dough layer that is fully baked or par-baked. Par-baked refers to partially baking such that the dough layer may still be partially raw or may no longer be raw but may not have undergone any browning or crisping. Unless otherwise specified, reference to “baked” or “baking” is intended to cover instances of fully baking or par-baking the dough layer 102.

As used herein, “crisp” or “crisping” can refer to a texture that is firm and may produce a slight cracking or crunching sound when cut, bit, or when other forms of pressure are applied. A crisp dough layer refers to a dough layer that is cooked, may be browned, and retains a palatable texture without becoming soggy or tough.

Crispness can be measured using the following technique. A probe and base plate may be used with a TAXT texture analyzer. A food item may be placed in or on a base plate and crushed with the probe while the TAXT texture analyzer measures the number of peaks and force generated as the outside of the food item fractures, cracks, or shatters.

The TAXT texture analyzer measures the peak forces generated as the probe descends and crushes the food item. In some examples, the first seconds that the food item is crushed simulates, in slow motion, a person taking a bite of the food item as the person’s teeth break through the outer layer (sometimes a crust) of the food item. The force and noise with which a food item breaks or fractures (rather than deforms) when “chewed” with the teeth can be measured to evaluate crispness.

When the dough layer 102 is baked or cooked in the pan 200, the dough layer 102 transitions from raw to a baked or cooked dough product that retains substantially the same shape as dough layer 102. The baked or cooked dough product likely will not retain an identical shape as dough layer 102 as the dough undergoes transformations during baking or cooking that necessarily impact the shape and size of the dough product. However, the shape of the baked or cooked dough product is substantially the same as dough layer 102.

The baked or cooked dough product, when removed from pan 200, retains the plurality of grooves 122 on the bottom surface 114. In some examples, the flat portions 128 may appear browned or crisp, while the plurality of grooves 122 remain lighter in color due to the escape of steam through the plurality of grooves 122 during baking or cooking. The depth and width of the plurality of grooves 122 likely is smaller than the depth and width of the raw dough when the plurality of grooves 122 are formed due to rising of the dough during baking or cooking.

In some examples, after baking or cooking, the dough layer 102 may be frozen.

In some examples, the dough layer 102 may not be baked or cooked in pan 200. After the dough layer 102 is formed by pressing a raw dough piece into pan 200, the dough layer may be removed from pan 200 without baking or cooking. The dough layer 102 may be baked or cooked outside of pan 200, though the baking or cooking process may result in the loss of definition of the plurality of grooves 122 in the bottom surface 114 of dough layer 102.

Alternatively, dough layer 102 may be frozen in a raw state with the plurality of grooves 122 in the bottom surface 114. Freezing dough layer 102 may allow for dough layer 102 to be removed from pan 200 without loss of the plurality of grooves 122 in the bottom surface 114. The frozen dough layer 102 may then be baked or cooked at a later date, with or without pan 200.

Once the dough layer 102 is formed (whether baked/cooked or raw), the microwavable food 100 comprising the dough layer 102 (such as pizza 101), may be further modified. For example, when the microwavable food 100 comprising dough layer 102 is a pizza 101, the pizza 101 may be topped with a variety of toppings. Some toppings include, but are not limited to, sauce, cheese, vegetables, fruits, meat, non-animal protein sources, non-dairy cheese, spices, seasonings, and combinations thereof.

In some examples, the microwavable food 100 may be modified in other ways, before or after forming the dough layer, including stuffing, filling, basting, brushing, folding, rolling, turning, twisting, cutting, layering, incorporating other components, and combinations thereof. In some examples, modifications to the dough layer 102 of the microwavable food 100 occur prior to pressing, stamping, extruding, or otherwise providing the plurality of grooves 122 on the dough layer. In some examples, modifications to the dough layer 102 of the microwavable food 100 occur after pressing, stamping, extruding, or otherwise providing the plurality of grooves 122 on the dough layer.

In some examples, the microwavable food 100 may be baked or cooked after undergoing further modifications following the formation of the dough layer 102. For example, a dough layer 102 may be formed for a pizza 101. The dough layer may then be parbaked and then topped with various toppings, and then baked further.

As another example, a dough layer 102 may be formed for a baguette, in which a dough piece may be placed in a pan 200 having a cavity and a corresponding lid with a plurality of ridges 222 inside the pan 200. When this version of pan 200 is closed with a dough piece inside, the cavity and lid imprint grooves on the dough layer 102. This example is not shown in the Figures but comprises substantially the same features as described and shown with respect to FIGS. 1-5. In such examples, the baguette may undergo proofing inside of the pan 200, and due to the rising of the dough in the pan 200, the dough piece may be imprinted with the plurality of grooves 122 as the dough rises in the pan 200. After the dough layer 102 is formed, the baguette may be brushed with a layer of oil or butter before baking, cooking, and/or freezing. In some examples, other bread or bread-like product could be produced in this manner.

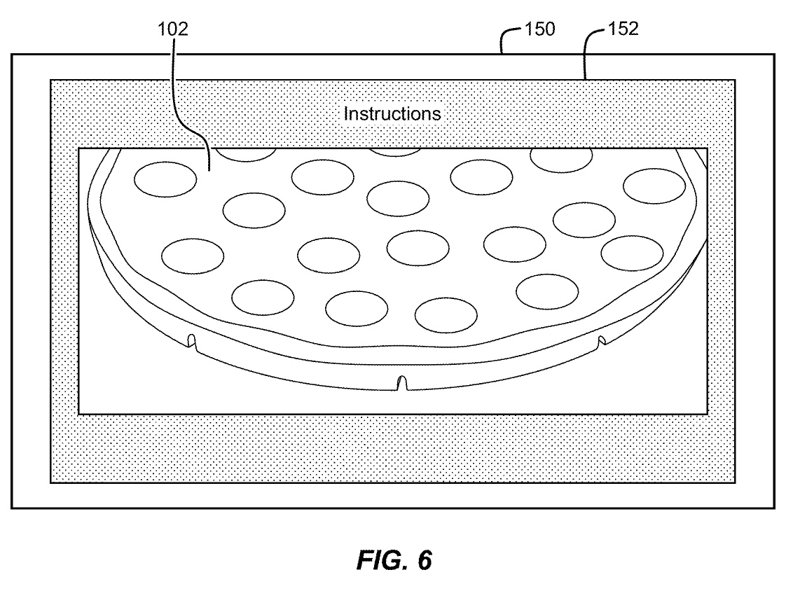

Once the microwavable food 100 comprising dough layer 102 has been formed, it may be packaged for distribution to consumers. The present disclosure contemplates various packaging materials and structures including, but not limited to, plastic, cardboard, recycled materials, ecologically friendly materials, boxes, bags, shrink-wrap, wrapping, vacuum sealing, and combinations thereof. FIG. 6 shows one schematic example of a package 150. However, the package may be any suitable packaging in the art.

The packaging 150 for the microwavable food 100 may also comprise instructions 152. Instructions 152 may include detailed steps for a consumer to follow to bake, cook, defrost, and/or reheat the microwavable food 100.

In some examples, instructions 152 comprise steps for cooking or heating the microwavable food 100 in a microwave 162. Instructions 152 may comprise a time period to microwave the microwavable food 100. For example, the instructions 152 may describe steps of removing the microwavable food 100 from packaging 150, placing on a microwave-safe cooking surface 160, and microwaving the microwavable food 100 for a period of time.

In some examples, the package 150 includes a susceptor material. Susceptors may be beneficial for microwave cooking because susceptor materials absorb electromagnetic energy (such as from a microwave) and converts the energy into heat for heating the microwavable food 100.

While the present disclosure discusses the preparation of microwavable foods 100 and microwaving the foods, other means and methods of cooking, baking, and/or heating are contemplated. In some examples, the foods disclosed herein may be cooked, baked, and/or heated using any means or heating appliance, including, but not limited to, conventional oven, convection oven, broiled, air-fryer, deep-fryer, vacuum-fryer, pan fryer, toaster oven, steamer, roaster, boiler, vacuum cooker, pressure cooker, induction cooker, conduction cooker, microwave, infrared cooker, radio-frequency cooker, combination cookers like an InstaPot® or Turbo Chef™, and combinations thereof. One or more of these means may be used sequentially or in tandem.

The dough layer 102, pan 200, and methods described herein may be beneficial for use with other means of cooking, baking, or heating described above. For example, a food item that is heated in an oven may benefit from the plurality of grooves 122 in the dough layer 102 as steam generated during baking in the oven may be routed through the plurality of grooves 122 and away from the food item.

The present disclosure also contemplates methods of making a microwavable food 100. One method of making a microwavable food 100 comprises removing the microwavable food 100 from a package 150, wherein the microwavable food 100 comprises a dough layer 102. The microwavable food 100 is placed in a microwave and microwaved in accordance with instructions provided with the package 150. As discussed herein, the dough layer 102 comprises a top surface 112, a bottom surface 114, and a perimeter sidewall 118 extending between the top surface and the bottom surface 114. The dough layer 102 further comprises a plurality of grooves 122 extending radially from a central location 126 on the bottom surface 114 to an outer circumference 120 of the dough layer 102 and further extending at least partially up the perimeter sidewall 118, wherein each of the plurality of grooves 122 terminates on the perimeter sidewall 118.

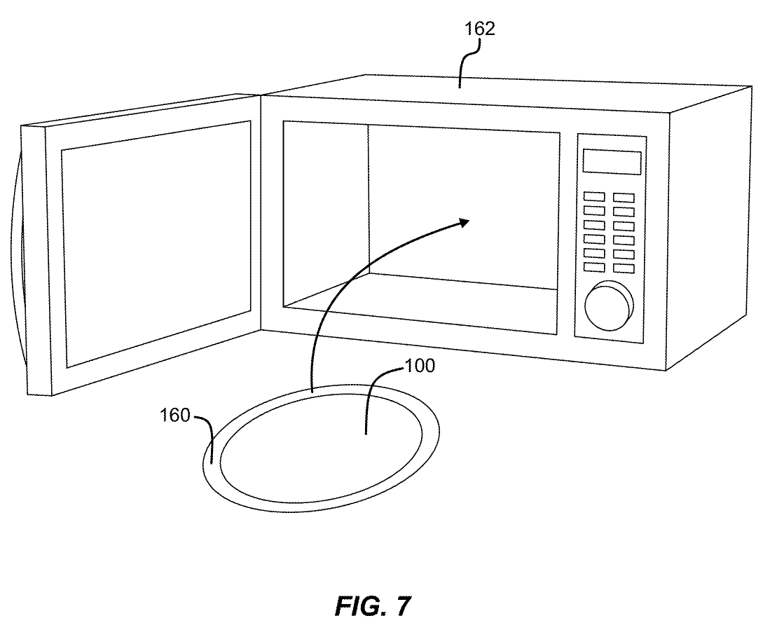

In some methods contemplated herein, after the microwavable food 100 is removed from the packaging 150, the microwavable food 100 may be placed on a cooking surface 160 prior to placing the microwavable food 100 in the microwave. An example is shown in FIG. 7. The cooking surface 160 may be any shape, including, but not limited to, circle, oval, square, rectangle, hexagon, octagon, or any other polygonal shape. The cooking surface may be any suitable material. In some examples, the cooking surface 160 is a susceptor.

During the microwaving step of the method, water molecules within the microwavable food 100 may be heated and converted to steam. Steam generated from the top surface 112 of the dough layer 102 can more easily dissipate from the microwavable food 100 as compared to steam generated from the bottom surface 114 of the dough layer 102. However, the plurality of grooves 122 in the bottom surface 114 of the dough layer 102 directs the travel of steam generated from the bottom surface 114 of the dough layer 102 away from the dough layer 102.

The microwaving step heats the microwavable food 100 such that generated steam travels radially through the plurality of grooves 122 along the bottom surface 114 from the central location 126 to the perimeter sidewall 118, in particular to the outer circumference 120 where the perimeter sidewall 118 meets the bottom surface 114. The steam further travels upwardly through the plurality of grooves 122 on the perimeter sidewall 118. An example of the path of the steam is indicated with a series of arrows 180, as shown in FIG. 1.

Without wishing to be bound by theory, it is believed that the steam generated by the flat portions 128 (particularly in parts of flat portions 128 closer to the central portion 126) moves to the plurality of grooves 122 such that the steam is routed from the bottom surface 114, to the grooves 122, through the grooves 122 radially to the outer circumference 120, and away from the dough layer 102 as described above.

The movement of steam through the plurality of grooves 122 moves steam away from the dough layer 102 that would otherwise be trapped under the bottom surface 114 of the dough layer 102, which may cause sogginess or toughness, lack of even heating throughout the dough layer 102, and/or lack of crispness. The microwaving step described herein with the dough layer 102 comprising the plurality of grooves 122 produces a more evenly heated microwavable food 100 with a crisp dough layer 102.

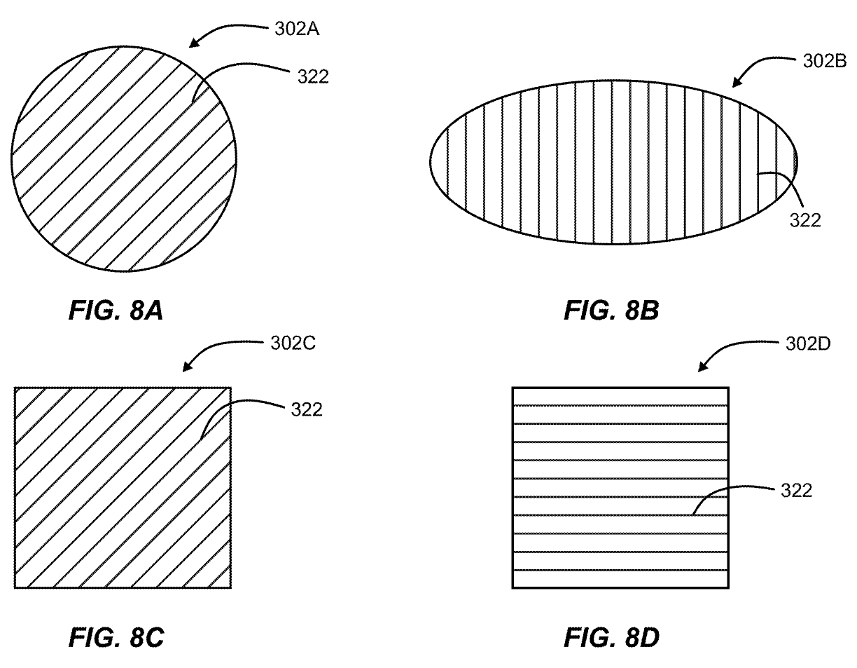

The present disclosure describes and shows examples where the plurality of grooves 122 on the dough layer 102 and the plurality of ridges 222 on the pan 200 are oriented radially. However, the present disclosure also contemplates other arrangements of grooves 122 and ridges 222. FIGS. 8A-8D show several examples of dough layers 302A-D with a plurality of grooves 322. In such examples, the plurality of grooves 322 run substantially parallel to other grooves 322, rather than in a radial orientation. When the plurality of grooves 322 are oriented in this manner, steam may still be routed from the underside of the dough layer 302 as described herein. For the sake of brevity, the descriptions herein regarding dough layer 102, pan 200, and their corresponding features are not described with respect to FIGS. 8A-8D, but the disclosure herein is intended to apply to the dough layers 302A-D and pans used to form dough layers 302A-D. Other arrangements are also contemplated such as grooves that are parallel, perpendicular, or angled from a center line where steam may still be routed from the underside of the dough layer using grooves that extend up the perimeter sidewall as described herein.

The following non-limiting examples are provided as illustrative embodiments. The numerical values set forth in the specific examples are reported as precisely as possible. Any numerical values, however, inherently contain certain errors necessarily resulting from the standard deviation found in their respective testing measurements. The examples are illustrative and may only show limited numerical quantities of the components described above. Only some examples are shown for the sake of brevity.

### Examples

### Example 1: Evaluating the impact of grooves on the perimeter sidewall of the dough layer

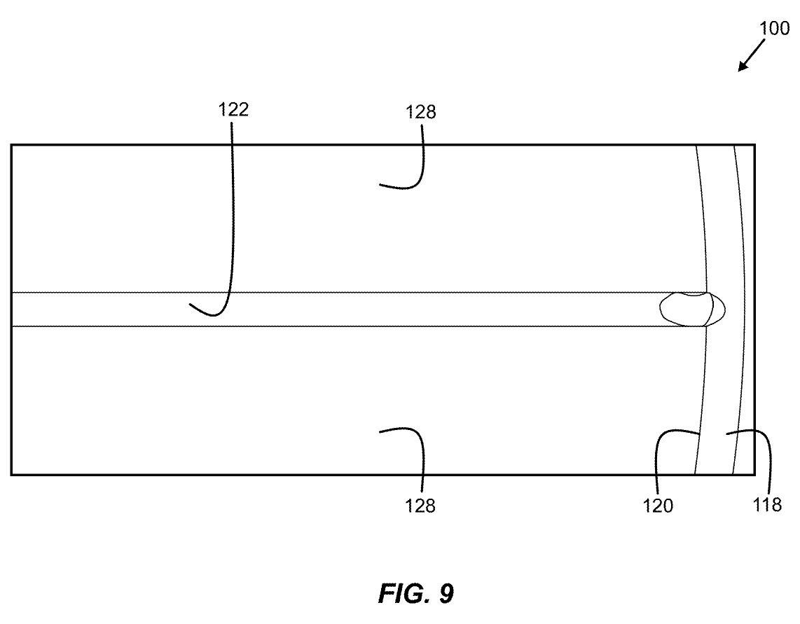

In this Example 1, the impact of the grooves on the perimeter sidewall of the dough layer was evaluated. A pizza comprising a dough layer was produced in accordance with the present disclosure. The dough layer comprised eight grooves on the bottom surface of the dough layer. However, after production of the dough layer, one groove was obstructed by dough, as shown in FIG. 9. The dough obstruction inhibited a continuous groove that extended from the central location of the dough layer on the bottom surface up the perimeter sidewall. Additionally, the dough obstruction mimicked an example where the dough layer does not include a groove on the perimeter sidewall and instead a groove that terminates on the bottom surface of the dough layer. Stated differently, the dough obstruction is a representative example of what happens when a groove exists only on the bottom surface of the dough and does not extend on the perimeter sidewall.

The dough layer was then topped, and the finished pizza was frozen and stored frozen until cooking. The pizza was removed from the freezer and its packaging and placed on a microwave safe cooking surface. The pizza was then microwaved until a minimum temperature of 165° F. was reached in all areas of the pizza. In doing so, steam was generated from water surpassing 212° F. in some areas of the pizza.

An infrared (IR) camera, mounted above the microwave turntable, was used to measure the IR heat signature of the surface area of the food during microwaving and converted it into a visible color map. An IR camera can capture the pattern of infrared radiation emitted by an object based on its temperature. The IR heat signatures were denoted by a color scale, with blue indicating a colder temperature, yellow indicating a warmer temperature, and red indicating a hotter temperature. For the purposes of this patent application, the images from the IR camera are shown in greyscale and are described using colors to demonstrate the temperatures in various parts of the pizza and using reference numbers to indicate the location of the described heat signatures.

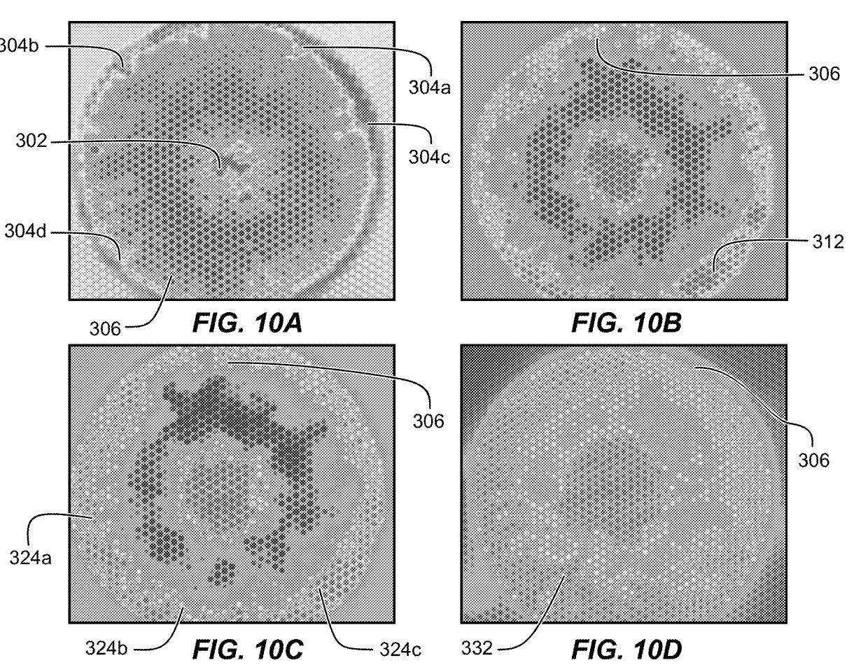

FIGS. 10A-10D illustrate the progression of the microwaving of the pizza. The pizza was rotating on a turntable in the microwave, and thus the views in FIGS. 10A-10D are slightly different due to the rotating nature of the pizza on the turntable. Therefore, a given section of the pizza that might be visible in one location in one view may be in a different location in another view as the pizza rotates.

In FIG. 10A, the center of the pizza 302 produced a red heat signature, indicating heat generation occurring around the central location of the pizza. Additionally, around the perimeter of the pizza, the sections of the pizza with the plurality of grooves near the perimeter sidewall 304a, 304b, 304c, 304d produced red and orange heat signatures, indicating that these regions were heating up faster than areas of the perimeter sidewall near the obstructed groove 306, which produced blue and green heat signatures.

As the pizza continued to heat up, FIG. 10B shows one side of the pizza 312 producing a red heat signature, meaning that side of the pizza was becoming warmer more quickly while the opposite side of the pizza demonstrated a blue heat signature indicating that the side of the pizza was heating up slower near the obstructed groove 306. The side of the pizza heating up more slowly (i.e., is colder) is the side of the pizza with the obstructed groove 306.

FIG. 10C shows the continued uneven heating of the pizza, with the side having an obstructed groove 306 continuing to heat up more slowly than the sides with unobstructed grooves in the dough layer 324a, 324b, 324c.

FIG. 10D shows the pizza near the end of microwaving, where one side of the pizza 332 has heated up substantially more than the opposite side of the pizza with the obstructed groove 306. The side of the pizza 332 with unobstructed grooves heated up faster and more evenly as compared to the side of the pizza with an obstructed groove 306. Additionally, the obstruction of one groove impacted the heating of larger section of the pizza than simply the one section with an obstructed groove. This suggests that a plurality of grooves disposed throughout the bottom surface of a food is important for generating even heating. Moreover, the presence of the plurality of grooves on the bottom surface of the food directs steam from the underside of the food, which also allows for improved contact with a susceptor (when used), leading to faster heating of the food and increased browning and crisping.

Additionally, the IR heat signature of the pizza shows that grooves extending from the bottom surface and up the sidewall of the dough layer have an important impact on heating of the dough layer. The presence of grooves only on the bottom surface of the dough layer, without extending up the sidewall of the dough layer, does not allow for the same movement of steam and heat from underneath the dough layer.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

Also described herein are aspects:
Aspect 1: A method of making a microwavable food, the method comprising: removing the microwavable food from a package, wherein the microwavable food comprises a dough layer comprising: a top surface; a bottom surface; a perimeter sidewall extending between the top surface and the bottom surface; and a plurality of grooves extending radially from a central location on the bottom surface to an outer circumference of the dough layer and further extending at least partially up the perimeter sidewall, wherein each of the plurality of grooves terminates on the perimeter sidewall; placing the microwavable food in a heating appliance; and cooking the microwavable food in accordance with instructions provided with the product
Aspect 2: The method of Aspect 1, wherein the microwavable food is a microwavable pizza.
Aspect 3: The method of Aspect 1 or Aspect 2, wherein the perimeter sidewall is a circumferential sidewall.
Aspect 4: The method of any one of Aspects 1-3, wherein the dough layer is baked, par-baked, or raw.
Aspect 5: The method of any one of Aspects 1-4, wherein the perimeter sidewall is oriented substantially perpendicularly to the bottom surface.
Aspect 6: The method of any one of Aspects 1-4, wherein the perimeter sidewall is oriented at an oblique angle relative to the bottom surface.
Aspect 7: The method of any one of Aspects 1-6, wherein the perimeter sidewall comprises a top edge where the perimeter sidewall meets the top surface of the dough layer.
Aspect 8: The method of Aspect 7, wherein each of the plurality of grooves terminates at the top edge.
Aspect 9: The method of Aspect 7, wherein each of the plurality of grooves terminates on the perimeter sidewall below the top edge.
Aspect 10: The method of any one of Aspects 1-9, wherein each of the plurality of grooves terminates at a tapered angle on the perimeter sidewall.
Aspect 11: The method of Aspect 10, wherein the tapered angle is between about 5 degrees and about 90 degrees.
Aspect 12: The method of any one of Aspects 1-11, further comprising the step of placing the microwavable food on a susceptor prior to placing the microwavable food in the microwave.
Aspect 13: The method of any one of Aspects 1-12, wherein the instructions comprise a time period to microwave the microwavable food for.
Aspect 14: The method of any one of Aspects 1-13, wherein the plurality of grooves comprises 2 to 12 grooves.
Aspect 15: The method of any one of Aspects 1-14, wherein the central location is free of grooves and is substantially flat.
Aspect 16: The method of Aspect 15, wherein the central location is substantially circular.
Aspect 17: The method of any one of Aspects 1-16, wherein the top surface of the dough layer is free of grooves and is substantially flat.
Aspect 18: The method of any one of Aspects 1-17, wherein the microwavable food is a pizza comprising one or more toppings selected from the group consisting of sauce, cheese, vegetables, fruits, meat, non-animal protein sources, non-dairy cheese, spices, seasonings, and combinations thereof.
Aspect 19: The method of any one of Aspects 1-18, wherein the microwaving step heats the microwavable food such that generated steam travels from flat portions located between the plurality of grooves, to the plurality of grooves, and radially through the plurality of grooves along the bottom surface from the central location to the perimeter sidewall.
Aspect 20: The method of Aspect 18, wherein the generated steam travels from the bottom surface of the dough layer to the outer circumference, located where the sidewall meets the bottom surface, and upwards through the plurality of grooves on the perimeter sidewall.
Aspect 21: The method of any one of Aspects 1-20, wherein the microwaving step produces a heated food where the dough layer is crisp.
Aspect 22: The method of any one of Aspects 1-21, wherein the package comprises a susceptor.
Aspect 23: The method of any one of Aspects 1-22, wherein the package comprises an outer packaging that encloses the microwavable food.
Aspect 24: A microwavable food, comprising: a dough layer comprising: a top surface; a bottom surface; a perimeter sidewall extending between the top surface and the bottom surface; and a plurality of grooves extending radially from a central location on the bottom surface to an outer circumference of the dough layer and further extending at least partially up the perimeter sidewall, wherein each of the plurality of grooves terminates on the perimeter sidewall.
Aspect 25: The microwavable food of Aspect 24, wherein the perimeter sidewall is oriented substantially perpendicularly to the bottom surface.
Aspect 26: The microwavable food of Aspect 24, wherein the perimeter sidewall is oriented at an oblique angle relative to the bottom surface.
Aspect 27: The microwavable food of any one of Aspects 24-26, wherein the perimeter sidewall of the dough layer comprises a top edge where the perimeter sidewall meets the top surface of the dough layer.
Aspect 28: The microwavable food of Aspect 27, wherein each of the plurality of grooves terminates at the top edge.
Aspect 29: The microwavable food of any one of Aspects 24-28, wherein each of the plurality of grooves terminates at a tapered angle on the perimeter sidewall.
Aspect 30: The microwavable food of Aspect 29, wherein the tapered angle is between about 5 degrees and about 90 degrees.
Aspect 31: The microwavable food of any one of Aspects 24-30, wherein the plurality of grooves comprises 2 to 12 grooves.
Aspect 32: The microwavable food of any one of Aspects 24-31, wherein the central location is free of grooves and is substantially flat.
Aspect 33: The microwavable food of Aspect 32, wherein the central location is substantially circular.
Aspect 34: The microwavable food of any one of Aspects 24-33, wherein the top surface of the dough layer is free of grooves and is substantially flat.
Aspect 35: The microwavable food of any one of Aspects 24-34, wherein the microwavable food is a pizza comprising one or more toppings selected from the group consisting of sauce, cheese, vegetables, fruits, meat, non-animal protein sources, non-dairy cheese, spices, seasonings, and combinations thereof.
Aspect 36: The microwavable food of any one of Aspects 24-35, wherein the microwavable food is frozen.
Aspect 37: The microwavable food of any one of Aspects 24-36, wherein the dough layer is baked, par-baked, or raw.
Aspect 38: The microwavable food of any one of Aspects 24-37, wherein the microwavable food is a pizza.
Aspect 39: A packaged microwavable food product comprising: a microwavable food comprising: a dough layer comprising: a top surface; a bottom surface; a perimeter sidewall extending between the top surface and the bottom surface; and a plurality of grooves extending radially from a central location on the bottom surface to an outer circumference of the dough layer and further extending at least partially up the perimeter sidewall, wherein each of the plurality of grooves terminates on the perimeter sidewall; and an outer packaging that encloses the microwavable food.
Aspect 40: The packaged microwavable food product of Aspect 39, further comprising a susceptor.
Aspect 41: The packaged microwavable food product of Aspect 39 or Aspect 40, further comprising instructions.
Aspect 42: The packaged microwavable food product of Aspect 41, wherein the instructions comprise instructions for cooking the microwavable food in a microwave.
Aspect 43: The packaged microwavable food product of any one of Aspects 39-42, wherein the microwavable food is frozen.
Aspect 44: The packaged microwavable food product of any one of Aspects 39-43, wherein the perimeter sidewall is oriented substantially perpendicularly to the bottom surface.
Aspect 45: The packaged microwavable food product of any one of Aspects 39-43, wherein the perimeter sidewall is oriented at an oblique angle relative to the bottom surface.
Aspect 46: The packaged microwavable food product of any one of Aspects 39-45, wherein the perimeter sidewall of the dough layer comprises a top edge where the perimeter sidewall meets the top surface of the dough layer.
Aspect 47: The packaged microwavable food product of Aspect 46, wherein each of the plurality of grooves terminates at the top edge.
Aspect 48: The packaged microwavable food product of any one of Aspects 39-47, wherein each of the plurality of grooves terminates at a tapered angle on the perimeter sidewall.
Aspect 49: The packaged microwavable food product of Aspect 48, wherein the tapered angle is between about 5 degrees and about 90 degrees.
Aspect 50: The packaged microwavable food product of any one of Aspects 39-49, wherein the plurality of grooves comprises 2 to 12 grooves.
Aspect 51: The packaged microwavable food product of any one of Aspects 39-50, wherein the dough layer is baked, par-baked, or raw.
Aspect 52: The packaged microwavable food product of any one of Aspects 39-51, wherein the microwavable food is a pizza.
Aspect 53: The packaged microwavable food product of any one of Aspects 39-52, wherein the perimeter sidewall is a circumferential sidewall.
Aspect 54: The packaged microwavable food product of any one of Aspects 39-53, wherein the central location is free of grooves and is substantially flat.
Aspect 55: The packaged microwavable food product of Aspect 54, wherein the central location is substantially circular.
Aspect 56: The packaged microwavable food product of any one of Aspects 39-55, wherein the top surface of the dough layer is free of grooves and is substantially flat.
Aspect 57: The packaged microwavable food product of any one of Aspects 39-56, wherein the microwavable food product is a pizza comprising one or more toppings selected from the group consisting of sauce, cheese, vegetables, fruits, meat, non-animal protein sources, non-dairy cheese, spices, seasonings, and combinations thereof.
Aspect 58: The packaged microwavable food product of any one of Aspects 39-57, wherein the microwavable food product is frozen.
Aspect 59: A slice of a microwavable pizza comprising: a dough layer comprising: a top surface; a bottom surface; and a perimeter sidewall, wherein the perimeter sidewall extends between the top surface and the bottom surface; at least one groove extending along the bottom surface and further extending at least partially up the perimeter sidewall, wherein the at least one groove terminates on the perimeter sidewall.
Aspect 60: The slice of microwavable pizza of Aspect 59, wherein the perimeter sidewall comprises three sidewalls.
Aspect 61: The slice of microwavable pizza of Aspect 59 or Aspect 60, wherein the slice of microwavable pizza is frozen.
Aspect 62: The slice of microwavable pizza of any one of Aspects 59-61, wherein the slice is enclosed within a package.
Aspect 63: The slice of microwavable pizza of Aspect 62, wherein the package further comprises at least one of an outer packing layer that encloses the slice of microwavable pizza, instructions for microwaving, and a susceptor.
Aspect 64: The slice of microwavable pizza of any one of Aspects 59-63, further comprising one or more toppings selected from the group consisting of sauce, cheese, vegetables, fruits, meat, non-animal protein sources, non-dairy cheese, spices, seasonings, and combinations thereof.

What is claimed is:

1. A method of making a microwavable food, the method comprising:
removing the microwavable food from a package, wherein the microwavable food comprises a dough layer comprising:
a top surface;
a bottom surface;
a perimeter sidewall extending between the top surface and the bottom surface; and
a plurality of grooves extending radially from a central location on the bottom surface to an outer circumference of the dough layer and further extending at least partially up the perimeter sidewall, wherein each of the plurality of grooves terminates on the perimeter sidewall;
placing the microwavable food in a heating appliance; and
cooking the microwavable food in accordance with instructions provided with the microwavable food.

2. The method of claim 1, wherein the perimeter sidewall is a circumferential sidewall.

3. The method of claim 1, wherein the perimeter sidewall comprises a top edge where the perimeter sidewall meets the top surface of the dough layer.

4. The method of claim 3, wherein each of the plurality of grooves terminates on the perimeter sidewall below the top edge.

5. The method of claim 4, wherein each of the plurality of grooves terminates at a tapered angle on the perimeter sidewall.

6. The method of claim 5, wherein the tapered angle is between about 5 degrees and about 90 degrees.

7. The method of claim 1, further comprising the step of placing the microwavable food on a susceptor prior to placing the microwavable food in the heating appliance.

8. The method of claim 1, wherein the plurality of grooves comprises 2 to 12 grooves.

9. The method of claim 1, wherein the central location is free of grooves and is substantially flat.

10. The method of claim 9, wherein the central location is substantially circular.

11. A microwavable food, comprising:
a dough layer comprising:
a top surface;
a bottom surface;
a perimeter sidewall extending between the top surface and the bottom surface; and
a plurality of grooves extending radially from a central location on the bottom surface to an outer circumference of the dough layer and further extending at least partially up the perimeter sidewall, wherein each of the plurality of grooves terminates on the perimeter sidewall.

12. The microwavable food of claim 11, wherein the perimeter sidewall of the dough layer comprises a top edge where the perimeter sidewall meets the top surface of the dough layer.

13. The method of claim 12, wherein each of the plurality of grooves terminates on the perimeter sidewall below the top edge.

14. The microwavable food of claim 13, wherein each of the plurality of grooves terminates at a tapered angle on the perimeter sidewall.

15. The microwavable food of claim 14, wherein the tapered angle is between about 5 degree and about 90 degrees.

16. The microwavable food of claim 11, wherein the plurality of grooves comprises 2 to 12 grooves.

17. The microwavable food of claim 11, wherein the central location is free of grooves and is substantially flat.

18. The microwavable food of claim 17, wherein the central location is substantially circular.

19. The microwavable food of claim 11, wherein the microwavable food is a pizza comprising one or more toppings selected from the group consisting of sauce, cheese, vegetables, fruits, meat, non-animal protein sources, non-dairy cheese, spices, seasonings, and combinations thereof.

20. A packaged microwavable food product comprising:
a microwavable food comprising:
a dough layer comprising:
a top surface,
a bottom surface;
a perimeter sidewall extending between the top surface and the bottom surface; and
a plurality of grooves extending radially from a central location on the bottom surface to an outer circumference of the dough layer and further extending at least partially up the perimeter sidewall, wherein each of the plurality of grooves terminates on the perimeter sidewall; and
an outer packaging that encloses the microwavable food.
